(19) United States
(12) Patent Application Publication
(10) Pub. No.: US 2010/0223377 A1
(43) Pub. Date: Sep. 2, 2010

(54) NETWORK MONITORING SYSTEM, SERVER APPARATUS, NETWORK MONITORING METHOD

(76) Inventor: Yusaku Hashimoto, Tokyo (JP)

Correspondence Address: Mr. Jackson Chen, 6535 N. STATE HWY 161, IRVING, TX, 75039, US

(21) Appl. No.: 12/682,601

(22) PCT Filed: Oct. 9, 2008
(86) PCT No.: PCT/JP2008/068803

§ 371 Date: Apr. 12, 2010

(30) Foreign Application Priority Data
Oct. 10, 2007 (JP) 2007-263865

(51) Int. Cl. G06F 15/173; G06F 15/16

(52) U.S. Cl. 709/224; 709/230

(57) ABSTRACT

A network monitoring system includes a server apparatus managing information of an optical transmission device in a network configured in a ring fashion and a client apparatus carrying out at least change of setting of the optical transmission device and check of apparatus condition thereof. A first protocol is used between the server apparatus and the client apparatus while a second protocol is uses between the server apparatus and the optical transmission apparatus. The first protocol and the second protocol are different from each other. The server apparatus includes a conversion portion carrying out mutual conversion between the first protocol and the second protocol.

### TECHNICAL FIELD

This invention relates to a network monitoring system, a server apparatus, and a network monitoring method used therein and, in particularly, to a network monitoring method in a communication system where a communication protocol between the server apparatus and a client apparatus in the network monitoring system and a communication protocol between the server apparatus and an optical transmission device in the network monitoring system are different from each other.

### BACKGROUND ART

As a transmission network related to this invention, there is a high-speed and a large-capacity network by comprising a plurality of ROADM (Reconfigurable Optical Add Drop Multiplexer) devices configured in a ling fashion by an optical fiber in a ring fashion and by combining a wavelength multiplexing method and technique of pass management. Each ROADM device is a kind of an optical transmission device.

As a system for monitoring such as the above-mentioned network, first network monitoring apparatuses (server apparatuses) and second network monitoring apparatuses (client apparatuses) are connected to the ROADM devices. Each first network monitoring apparatus (server apparatus) monitors information of the ROADM devices. Each second network monitoring apparatus (client apparatus) carries out change of setting of the ROADM devices and check of apparatus condition (an alarm or the like) thereof.

Under the circumstances, a first protocol is used between the first network apparatus (the server apparatus) and the second network apparatus (the client apparatus) while a second protocol is used between the first network apparatus (the server apparatus) and the optical transmission device (the ROADM device). The first protocol and the second protocol are different from each other. The first protocol may be, for example, a TCP/IP (Transmission Control Protocol/Internet Protocol) protocol while the second protocol may be, for example, an OSI (Open Systems interconnection) protocol.

Herein, the OSI protocol has a hierarchical structure which may comprise, for example, first through seventh layers as follows. The first layer is an L1 (a layer 1). The second layer is an L2 (a layer 2). The third layer is a CLNP (Connectionless Network Protocol). The fourth layer is a TP4 (Transport Protocol Class 4). The fifth layer is a COSP (Connection Oriented Session Protocol). The sixth layer is a COPP (Connection Oriented Presentation Protocol). The seventh layer is an ACSE (Association Control Service Element).

The IP has a hierarchical structure which may comprises, for example, first through fifth layers as follows. The first layer is the L1 (the layer 1). The second layer is the L2 (the layer 2). The third layer is an IP (Internet Protocol). The fourth layer is a TCP (Transmission Control Protocol). The fifth layer is an HTTP (Hyper Text Transfer Protocol).

Inasmuch as different protocols are used in the above-mentioned transmission network such that the first protocol (the TCP/IP protocol) is used between the second network monitoring apparatus (the client apparatus) and the first network monitoring apparatus (the server apparatus) and the second protocol (the OSI protocol) is used between the first network monitoring apparatus (the server apparatus) and the optical transmission device, there is a problem such that it is impossible to render a service using a Web browser for the optical transmission device via the OSI protocol (the second protocol).

In a case where the OSI protocol is used, there is no mechanism to pass an HTTP (Hyper Text Transfer Protocol) packet through. It is therefore impossible to use a Web server function mounted on the optical transmission device. Accordingly, it is necessary to develop renewed special-purpose software for performing access for the optical transmission device and it results in increasing development costs. In addition, it is necessary for a user to entail purchase expenses of the special-purpose software and this becomes a factor that cannot cut initial costs.

In addition, if the special-purpose software is not mounted on a maintenance terminal to be operated on performing maintenance by the user, it is impossible to access the optical transmission device. It is therefore necessary to always prepare a personal computer (PC) on which the special-purpose software is mounted on supporting maintenance. Furthermore, if the special-purpose software matched with version of the optical transmission device cannot be not prepared, a mismatch occurs between the optical transmission device and version of the special-purpose software and it results in occurring a problem such that it is impossible to access the optical transmission device.

In addition, as an optical transmission network, there is technique disclosed, for example, in Japanese Unexamined Patent Application Publication JP-A 2004-032633 which will later be referred to as “Patent Document 1.” The Patent Document 1 inexpensively provides a system and method for monitoring a transmission network by which a high-quality OAM (Operations, Administration and Maintenance) service can be provided with a small number for monitoring devices regardless of the number of systems provided with the OAM service.

In the optical transmission network disclosed in the Patent Document 1, different protocols are not used between the second network monitoring apparatus (the client apparatus) and the first network monitoring apparatus (the server apparatus) and between the first network monitoring apparatus (the server apparatus) and the optical transmission device, respectively. As a result, in technique disclosed in the Patent Document 1, it is impossible to resolve the problem in a case of using the different protocols.

In addition, Japanese Unexamined Patent Application Publication JP-A 11-275170 (which corresponds to U.S. Pat. No. 6,400,729), which will later be referred to as “Patent Document 2”, discloses a protocol conversion system which is provide to secure a highly reliable and smooth data communication between different two types of networks.

Furthermore, WO2004/012414, which will later be referred to as “Patent Document 3”, discloses a system and method for communicating data between networks operating under different protocols.

In addition, Japanese Unexamined Patent Application Publication JP-A 2000-286848, which will later be referred to s “a Patent Document 4”, discloses an integrated network management system by means of distributed arrangement of management interface conversion sections.

### DISCLOSURE OF INVENTION

It is an exemplary object of this invention to provide a network monitoring system, a server apparatus, and a network monitoring method used thereto, which are capable of improving extra maintenance.

According to an exemplary aspect of this invention, a network monitoring system comprises an optical transmission device in a network configured in a ring fashion, a server apparatus managing information of the optical transmission device, and a client apparatus carrying out at least change of setting of the optical transmission device and check of apparatus condition thereof. The network monitoring system uses a first protocol between the server apparatus and the client apparatus and uses a second protocol between the server apparatus and the optical transmission device. The first protocol and the second protocol are different from each other. The server apparatus comprises a conversion portion carrying out mutual conversion between the first protocol and the second protocol.

According to another exemplary aspect of this invention, a server apparatus manages information of an optical transmission device in a network configured in a ring fashion. The server apparatus comprises a conversion portion carrying out mutual conversion between a first protocol between the sever apparatus and a client apparatus and a second protocol between the server apparatus and the optical transmission device.

According to still another exemplary aspect of this invention, a network monitoring method is used in a network comprising an optical transmission device in the network configured in a ring fashion, a server apparatus monitoring information of the optical transmission device, and a client apparatus carrying out at least change of setting of the optical transmission device and check of apparatus condition thereof. The network uses a first protocol between the server apparatus and the client apparatus and uses a second protocol between the server apparatus and the optical transmission device. The first protocol and the second protocol are different from each other. The server apparatus performs conversion processing for carrying out mutual conversion between the first protocol and the second protocol.

According to yet another exemplary aspect of this invention, a program is for making a server apparatus for managing information of an optical transmission device in a network configured in a ring fashion execute conversion processing for carrying out mutual conversion between a first protocol between the server apparatus and a client apparatus and a second protocol between the server apparatus and the optical transmission device.

### BRIEF DESCRIPTION OF DRAWINGS:

FIG. 1 is a block diagram showing structure of a network monitoring system according to an exemplary embodiment of this invention;

FIG. 2 is a view showing detail on carrying out connection to an optical transmission device from a Web browser on a second network monitoring apparatus (a client apparatus) for use in the network monitoring system illustrated in FIG. 1; and

FIG. 3 is a sequence chart showing operation on carrying out connection to the optical transmission device from the Web browser on the second network monitoring apparatus (the client apparatus) for use in the network monitoring system illustrated in FIG. 1.

### BEST MODE FOR CARRYING OUT THE INVENTION

Now, the description will be made as regards an embodiment of a network monitoring system, a server apparatus, a network monitoring method, and a program according to this invention with reference of attached drawings.

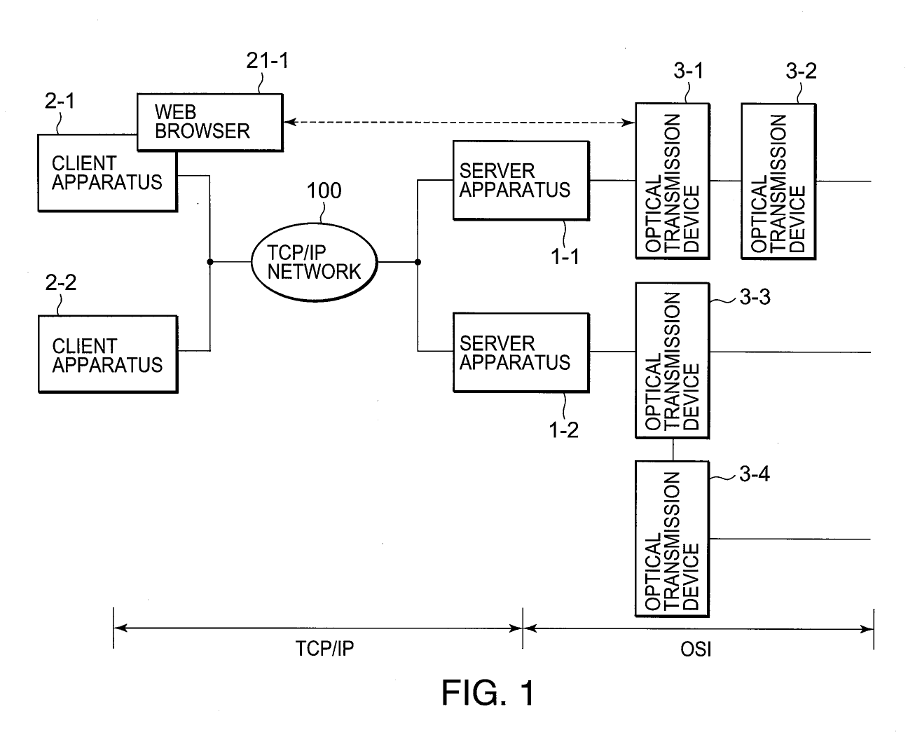

FIG. 1 is a block diagram showing construction of the network monitoring system according to an exemplary embodiment of this invention. The illustrated network monitoring system comprises first and second server apparatuses 1-1 and 1-2, first and second client apparatuses 2-1 and 2-2, and first through fourth optical transmission devices 3-1, 3-2, 3-3, and 3-4. Each of the first and the second server apparatuses 1-1 and 1-2 is also called a first network monitoring apparatus while each of the first and the second client apparatuses 2-1 and 2-2 is also called a second network monitoring apparatus. Each of the first through the fourth optical transmission devices 3-1 to 3-4 comprises, for example, a ROADM (Reconfigurable Optical Add Drop Multiplexer) device. The number of the server apparatuses, the number of the client apparatuses, and the number of the optical transmission devices are not restricted to them illustrated in FIG. 1.

The first and the second client apparatuses (the second network monitoring apparatuses) 2-1 and 2-2 are connected to the first and the second server apparatuses (the first network monitoring apparatuses) 1-1 and 1-2 through a TCP/IP (Transmission Control Protocol/Internet Protocol) network 100. The first and the second server apparatuses (the first network monitoring apparatuses) 1-1 and 1-2 are connected to the first through the fourth optical transmission devices 3-1 to 3-4 by means of an OSI (Open Systems Interconnection) protocol. In addition, in the example being illustrated, a TCP/IP protocol on the TCP/IP network 100 is also called a first protocol while the OSI protocol is also called a second protocol.

The first and the second client apparatuses 2-1 and 2-2 carry out change of setting of the first through the fourth optical transmission devices 3-1 to 3-4 and check of device conditions (an alarm or the like) thereof. The first and the second server apparatuses 1-1 and 1-2 manage, using a database (not shown), information of the first through the fourth optical transmission devices 3-1 to 3-4 in a network configured in a ring fashion.

From the first and the second client apparatuses 2-2 and 2-2 up to the first and the second server apparatuses 1-1 and 1-2, Web screen request data for detail setting of the first through the fourth optical transmission devices 3-1 to 3-4 are transmitted via a HTTP (Hyper Text Transfer Protocol) (TCP/IP).

After receiving the Web screen request data, each of the first and the second server apparatuses 1-1 and 1-2 encapsulates a received HTTP (TCP/IP) packet by means of the OSI protocol in order to transmit the Web screen request data to the first through the fourth optical transmission devices 3-1 to 3-4 on a network of the OSI protocol (the second protocol). Each of the first and the second server apparatuses 1-1 and 1-2 transmits an encapsulated packet (a packet of the OSI protocol) to the first through the fourth optical transmission devices 3-1 to 3-4.

Each of the first through the fourth optical transmission devices 3-1 to 3-4 removes an OSI header from a received packet of the OSI protocol to obtain the HTTP (TCP/IP) packet. Each of the first through the fourth optical transmission devices 3-1 to 3-4 analyzes, using a Web server function therein, request contents of the HTTP (TCP/IP) packet and prepares, by the HTTP (TCP/IP) packet, display screen data of detail setting of the first through the fourth optical transmission devices 3-1 to 3-4 requested.

Each of the first through the fourth optical transmission devices 3-1 to 3-4 encapsulates a prepared HTTP (TCP/IP) packet by means of the OSI protocol and transmits an encapsulated packet (replay data) to the first and the second server apparatuses 1-1 and 1-2.

Each of the first and the second server apparatuses 1-1 and 1-2 removes an OSI protocol header from received replay data (namely, decapsulates) to obtain a HTTP (TCP/IP) packet. Thereafter, each of the first and the second server apparatuses 1-1 and 1-2 transmits the HTTP (TCP/IP) packet to the first and the second client apparatuses 2-1 and 2-2 serving as request sources.

Inasmuch as there are a plurality of second network monitoring apparatuses (client apparatuses) with respect to one first network monitoring apparatus (server apparatus) in the exemplary embodiment, a function is realized by making a mechanism for bring a TCP/IP port on receiving request data from the second network monitoring apparatus (the client apparatus) into correspondence with an OSI port for transmitting the request data.

In the transmission network related to this invention, different protocols are used such that the TCP/IP protocol (the first protocol) is used between the second network monitoring apparatus (the client apparatus) and the first network monitoring apparatus (the server apparatus) and the OSI protocol (the second protocol) is used between the first network monitoring apparatus (the server apparatus) and the optical transmission device. It is therefore impossible to render a service using the Web browser for the first through the fourth optical transmission devices 3-1 to 3-3 through the OSI protocol (the second protocol).

In marked contrast, in the exemplary embodiment of the present invention, by mounting, on the first network monitoring apparatuses (the server apparatuses) 1-1 and 1-2, a function (a conversion portion) for carrying out mutual conversion between the TCP/IP protocol (the first protocol) and the OSI protocol (the second protocol), it is possible to render a service using the Web browser for the first through the fourth optical transmission devices 3-1 to 3-3 through the OSI protocol (the second protocol).

For this reason, in the exemplary embodiment of the present invention, by developing a mechanism for making the HTTP packet pass through on the OSI protocol (the second protocol), it is possible to carry out access to the first through the fourth optical transmission devices 3-1 to 3-4 from the Web browser of maintenance terminals (the client apparatuses 2-1 and 2-2). In addition, inasmuch as the exemplary embodiment of the present invention uses the Web server function of the optical transmission devices, a mismatch does not occurs between the special-purpose software and version of the optical transmission device and it is possible to improve exceptionally maintenance.

FIG. 1 shows a flow for carrying out connection from the second network monitoring apparatus (the first client apparatus) 2-1 to the first optical transmission device 3-1 by a Web browser 21-1 in the first client apparatus 2-1.

The exemplary embodiment of the present invention realizes a mechanism for enabling to connect the second network monitoring apparatus (the first client apparatus) 2-1 with the first optical transmission device 3-1 laying on a network of the OSI protocol (the second protocol) through the first network monitoring apparatus (the first server apparatus) 1-1 by means of the Web browser 21-1 which operates on the second network monitoring apparatus (the first client apparatus) 2-1 and to set detail of the first optical transmission device 3-1.

From the second network monitoring apparatus (the first client apparatus) 2-1 up to the first network monitoring apparatus (the first server apparatus) 1-1, the Web screen request data for detail setting of the first optical transmission device 3-1 is transmitted via the HTTP (TCP/IP).

After receiving the Web screen request data from the second network monitoring apparatus (the first client apparatus) 2-1, the first network monitoring apparatus (the first server apparatus) 1-1 encapsulates a received HTTP (TCP/IP) packet by means of the OSI protocol (the second protocol) in order to transmit request data to the first optical transmission device 3-1 on the network of the OSI protocol (the second protocol). And, the first network monitoring apparatus (the first client apparatus) 1-1 transmits an encapsulated packet to the first optical transmission device 3-1.

The first transmission device 3-1 removes the OSI header from a received packet of the OSI protocol (the second protocol) to obtain the HTTP (TCP/IP) packet. The Web server function in the optical transmission device 3-2 analyzes request contents in the HTTP (TCP/IP) packet and prepares, by an HTTP (TCP/IP) packet, the display screen data for detail setting of the first optical transmission device 3-1 requested.

The first optical transmission device 3-1 encapsulates a prepared HTTP (TCP/IP) packet by means of the OSI protocol (the second protocol) and transmits an encapsulated packet (replay data) to the first network monitoring apparatus (the first server apparatus) 1-1.

The first network monitoring apparatus (the first server apparatus) 1-1 removes the OSI protocol header from received replay data (namely, decapsulates) to obtain the HTTP (TCP/IP) packet. Thereafter, the first network monitoring apparatus (the first server apparatus) 1-1 transmits the HTTP (TCP/IP) packet to the second network monitoring apparatus (the first client apparatus) 2-1 serving as the request source.

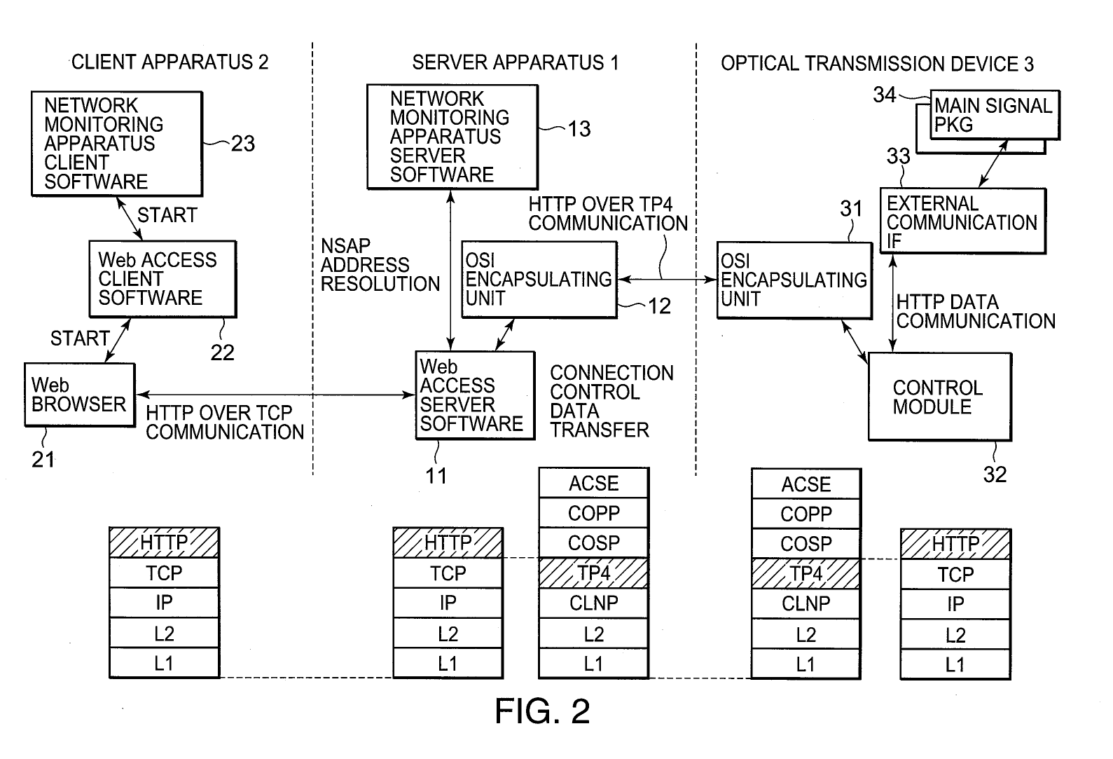

FIG. 2 is a view showing detail on carrying out connection to an optical transmission device 3 from a Web browser 21 on a second network monitoring apparatus (a client apparatus) 2 in the exemplary embodiment of the present invention.

Herein, in FIG. 2, the OSI protocol has a hierarchical structure which comprises first through seventh layers as follows. The first layer is an L1 (a layer 1). The second layer is an L2 (a layer 2). The third layer is a CLNP (Connectionless Network Protocol). The fourth layer is a TP4 (Transport Protocol Class 4). The fifth layer is a COSP (Connection Oriented Session Protocol). The sixth layer is a COPP (Connection Oriented Presentation Protocol). The seventh layer is an ACSE (Association Control Service Element).

On the other hand, the IP has a hierarchical structure which comprises first through fifth layers as follows. The first layer is the L1 (the layer 1). The second layer is the L2 (the layer 2). The third layer is an IP (Internet Protocol). The fourth layer is a TCP (Transmission Control Protocol). The fifth layer is an HTTP (Hyper Text Transfer Protocol).

In addition, in FIG. 2, the second network monitoring apparatus (the client apparatus) 2 comprises the Web browser 21, a Web access client software 22, and a network monitoring apparatus client software 23.

The first network monitoring apparatus (the server device) 1 comprises a Web access server software 11, an OSI encapsulating unit 12, and a network monitoring apparatus server software 13.

The optical transmission device 3 comprises an OSI encapsulating unit 31, a control module 32, an external communication interface (IF) 33, and main signal packages (PKGs) 34.

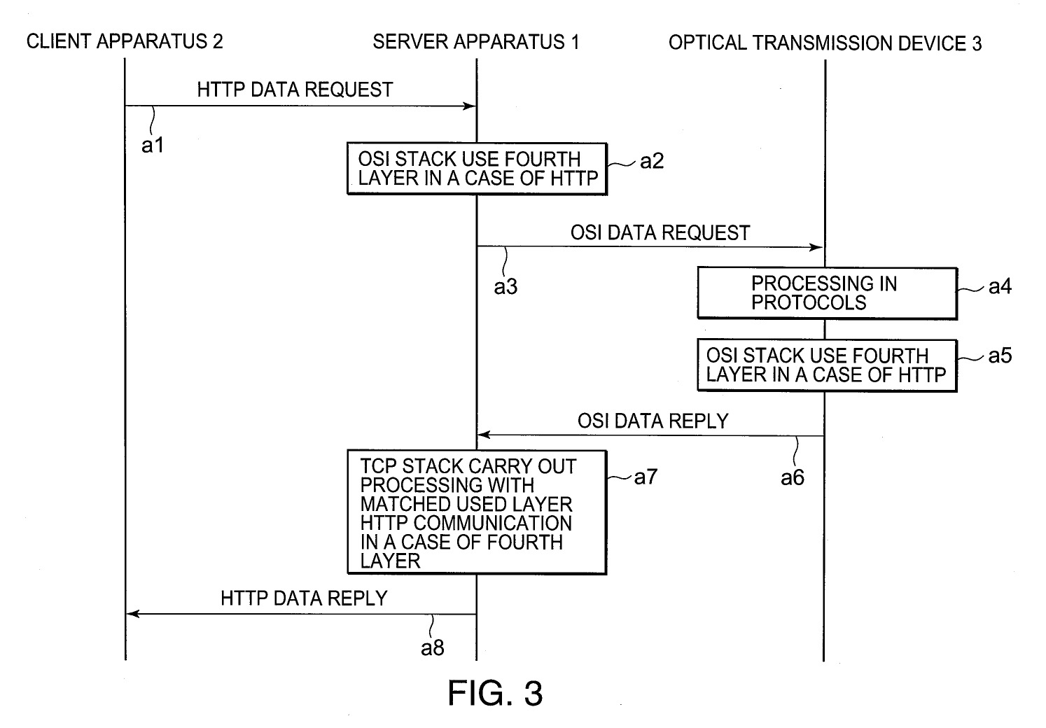

FIG. 3 is a sequence chart showing operation on carrying out connection to the optical transmission device 3 from the Web browser 21 on the second network monitoring apparatus (the client apparatus) 2 in the exemplary embodiment of the present invention.

Referring now to FIGS. 2 and 3, description will be made as regards operation on carrying out connection to the optical transmission device 3 from the Web browser 21 on the second network monitoring apparatus (the client apparatus) 2 in the exemplary embodiment of the present invention.

The second network monitoring apparatus (the client apparatus) 2 for managing the optical transmission device 3 performs a menu selection by means of the network monitoring client software 23 to notify the Web access client software 22 of a message.

Notified of the message, the Web access client software 22 changes detail setting on the second network monitoring apparatus (the client apparatus) 2, obtains information of a target apparatus from symbol information of the optical transmission device 3 referred, and starts the Web browser 21. The Web browser 21 transmits, to the first network monitoring apparatus (the server apparatus) 1, the Web screen request data for detail setting of the optical transmission device 3 via the HTTP (TCP/IP) (a1 in FIG. 3).

On the first network monitoring apparatus (the server apparatus) 1, the Web access server software 11 accesses the network monitoring apparatus server software 13 to resolve an NSAP (Network Service Access Point) address value for the optical transmission device 3 designated, and performs connection with the optical transmission device 3 by means of the fourth layer [TP4 (Transport Protocol Class 4)] on the OSI protocol.

After the completion of the connection, the first network monitoring apparatus (the server apparatus) 1 encapsulates, by means of the OSI encapsulating unit 12, received data (the Web screen request data for detail setting of the optical transmission device 3) and transmits encapsulated data (OSI protocol data) to the optical transmission device 3 (a2 and a3 in FIG. 3).

In the optical transmission device 3, the control module 32 for controlling the OSI protocol receives the OSI protocol data and removes data of the fourth layer (TP4) from received OSI protocol data to obtain the HTTP (TCP/IP) packet.

The control module 32 transmits received data to the external communication interface 33 for controlling a server function of a Web browser of the optical transmission device 3. The external communication interface 33 analyzes received HTTP (TCP/IP) data to prepare HTTP (TCP/IP) replay data. The external communication interface 33 sends prepared replay data to the control module 32 (a4 and a5 in FIG. 3).

The control module 32 encapsulates, by means of the OSI encapsulating unit 31, the HTTP (TCP/IP) replay data with the OSI protocol and transmits encapsulated replay data to the first network monitoring apparatus (the server apparatus) 1 via the OSI protocol (a6 in FIG. 3).

The first network monitoring apparatus (the server apparatus) 1 removes, by means of the OSI encapsulating unit 12, the OSI protocol header from received replay data (namely, decapsulates) to obtain an HTTP (TCP/IP) packet. Thereafter, the first network monitoring apparatus (the server apparatus) 1 transmits the HTTP (TCP/IP) packet to the second network monitoring apparatus (the client apparatus) 2 serving as the request source for transmitting the request data (a7 and a8 in FIG. 3).

The second network monitoring apparatus (the client apparatus) 2 displays data on a screen of the Web browser 21 on the basis of received HTTP (TCP/IP) data.

In the manner which is described above, in the exemplary embodiment, the first network monitoring apparatus (the server apparatus) 1 integrates (namely, encapsulates) the HTTP (TCP/IP) packet from the second network monitoring apparatus (the client apparatus) into the fourth layer (TP4) of the OSI protocol to transmit integrated data to the optical transmission device 3.

Conversely, as regards the replay data from the optical transmission device 3, the first network monitoring apparatus (the server apparatus) 1 extracts (namely, decapsulates) a HTTP (TCP/IP) packet from the fourth layer (TP4) of the OSI protocol to transmit extracted packet to the second network monitoring apparatus (the client apparatus) 2 by means of the TCP/IP. In addition, integrating the HTTP (TCP/IP) packet into the fourth layer (TP4) of the OSI protocol and extracting the HTTP (TCP/IP) packet from the fourth layer (TP4) of the OSI protocol can be realized by means of a well-known method.

Thus, in the exemplary embodiment of the present invention, by mounting, in the first network monitoring apparatus (the server apparatus) 1, a function (the OSI encapsulating unit 12) for carrying out mutual conversion between the TCP/IP protocol (the first protocol) and the OSI protocol (the second protocol), it is possible to render a service using the Web browser for the optical transmission device 3 via the OSI protocol (the second protocol).

In the manner which is described above, the present invention is characterized in that it is possible to realize the mutual conversion between the TCP/IP protocol (the first protocol) and the OSI protocol (the second protocol). That is to say, the present invention realizes a mechanism for enabling to connect, by means of the Web browser 21 operating on the second network monitoring apparatus (the client apparatus) 2, the second network monitoring apparatus (the client apparatus) 2 with the optical transmission device 3 laying on the network of the OSI protocol (the second protocol) through the first network monitoring apparatus (the server apparatus) 1 and to set detail of the optical transmission device 3.

While this invention has been described particularly shown and described with reference to an exemplary embodiment thereof, the invention is not limited to this embodiment. It will be understood by those of ordinary skill in the art that various changes in form and details may be made therein without departing from the sprit and scope of the present invention as defined by the claim. For example, although the HTTP (TCP/IP) packet is used in the above-mentioned exemplary embodiment, a TL1 command may be used in lieu of the HTTP (TCP/IP) packet. In this event, the TL1 command is integrated (or, encapsulated) into the seventh layer (ACSE) on the OSI protocol. In addition, although the TCP/IP over OSI is used in the above-mentioned exemplary embodiment, an OSI over TCP/IP may be made availably by supporting a function of an inverse conversion. This can provide a mechanism for connecting the second network monitoring apparatus (the client apparatus) with the optical transmission device as regards a combination of the OSI protocol between the second network monitoring apparatus (the client apparatus) and the first network monitoring apparatus (the server apparatus) and the TCP/IP protocol between the first network monitoring apparatus (the server apparatus) and the optical transmission device.

This application is based upon and claims the benefit of priority from Japanese patent application No. 2007-263865, filed on Oct. 10, 2007, the disclosure of which is incorporated herein in its entirely by reference.

1. A network monitoring system comprising:
an optical transmission device in a network configured in a ring fashion;
a server apparatus managing information of said optical transmission device; and
a client apparatus carrying out at least change of setting of said optical transmission device and check of apparatus condition thereof,
wherein said network monitoring system uses a first protocol between said server apparatus and said client apparatus and uses a second protocol between said server apparatus and said optical transmission device, said first protocol and said second protocol being different from each other,
wherein said server apparatus comprises a conversion portion carrying out mutual conversion between said first protocol and said second protocol.

2. The network monitoring system as claimed in claim 1, wherein said conversion portion encapsulates first data from said client apparatus to said optical transmission device using said second protocol and decapsulates second data from said optical transmission device to said client apparatus using said first protocol.

3. The network monitoring system as claimed in claim 1, wherein said client apparatus comprises a Web browser accessing said optical transmission device to carry out detail setting of said optical transmission device.

4. The network monitoring system as claimed in claim 1, wherein said network monitoring system uses a TCP/IP (Transmission Control Protocol/Internet Protocol) protocol as said first protocol and uses an OSI (Open Systems Interconnection) protocol as said second protocol, whereby uses TCP/IP over OSI.

5. The network monitoring system as claimed in claim 1, wherein said network monitoring system uses an OSI (Open Systems Interconnection) protocol as said first protocol and uses a TCP/IP (Transmission Control Protocol/Internet Protocol) protocol as said second protocol, whereby uses OSI over TCP/IP.

6. A server apparatus managing information of an optical transmission device in a network configured in a ring fashion, comprising
a conversion portion carrying out mutual conversion between a first protocol between said sever apparatus and a client apparatus and a second protocol between said server apparatus and said optical transmission device.

7. The server apparatus as claimed in claim 6, wherein said conversion portion encapsulates first data from said client apparatus to said optical transmission device using said second protocol and decapsulates second data from said optical transmission device to said client apparatus using said first protocol.

8. The server apparatus as claimed in claim 6, wherein a TCP/IP (Transmission Control Protocol/Internet Protocol) is uses as said first protocol and an OSI (Open Systems Interconnection) protocol is uses as said second protocol, whereby uses TCP/IP over OSI.

9. The server apparatus as claimed in claim 6, wherein an OSI (Open Systems Interconnection) protocol is used as said first protocol and a TCP/IP (Transmission Control Protocol/Internet Protocol) protocol is used as said second protocol, whereby uses OSI over TCP/IP.

10. A network monitoring method for use in a network comprising an optical transmission device in the network configured in a ring fashion, a server apparatus monitoring information of said optical transmission device, and a client apparatus carrying out at least change of setting of said optical transmission device and check of apparatus condition thereof, said network using a first protocol between said server apparatus and said client apparatus and said network using a second protocol between said server apparatus and said optical transmission device, said first protocol and said second protocol being different from each other, wherein said method comprising:
performing, in said server apparatus, conversion processing for carrying out mutual conversion between said first protocol and said second protocol.

11. The network monitoring method as claimed in claim 10, wherein in said conversion processing, said server apparatus encapsulates first data from said client apparatus to said optical transmission device using said second protocol and decapsulates second data from said optical transmission device to said client apparatus using said first protocol.

12. The network monitoring method as claimed in claim 10, wherein said client apparatus comprises a Web browser accessing said optical transmission device to carry out detail setting of said optical transmission device.

13. The network monitoring method as claimed in claim 10, wherein a TCP/IP (Transmission Control Protocol/Internet Protocol) protocol is used as said first protocol, an OSI (Open Systems Interconnection) protocol is used as said second protocol, whereby uses TCP/IP over OSI.

14. The network monitoring method as claimed in claim 10, wherein an OSI (Open Systems Interconnection) protocol is used as said first protocol, a TCP/IP (Transmission Control Protocol/Internet Protocol) protocol is used as said second protocol, whereby uses OSI over TCP/IP.

15. (canceled)
